(19) United States
(12) Patent Application Publication
(10) Pub. No.: US 2026/0251005 A1
(43) Pub. Date: Aug. 27, 2026

(54) VACUUM INSULATED PANEL WITH EVACUATION BORE STRUCTURE FORMED IN GLASS SUBSTRATE AND METHOD

(71) Applicant: LuxWall, Inc., Ypsilanti, MI (US)

(72) Inventors: Christian BISCHOFF, Maumee, OH (US); Andrew Kucher, Ann Arbor, MI (US)

(21) Appl. No.: 19/064,872

(22) Filed: Feb. 27, 2025

(51) Int. Cl. E06B 3/66; B32B 3/08; B32B 3/30; B32B 17/06; C03C 3/078; C03C 23/00; E06B 3/677

(52) U.S. Cl. CPC E06B 3/6612; B32B 3/085; B32B 3/30; B32B 17/06; C03C 3/078; C03C 23/0025; E06B 3/6775; B32B 2307/7375; B32B 2607/00

(57) ABSTRACT

A vacuum insulating panel may include substrates, a plurality of spacers provided in a gap between substrates, wherein the gap is at pressure less than atmospheric pressure, and an evacuation bore structure for evacuating the gap. The evacuation bore structure may be carved (e.g., carved via laser(s) or otherwise) or otherwise formed into a substrate such as a glass substrate. Following evacuation, the evacuation bore structure may be sealed (e.g., via laser or otherwise) using material from the bore structure itself. Thus, the evacuation bore structure may be configured so that there is no need for any separate seal material to be added to seal any joint separating the low pressure area from the atmospheric pressure surrounding area.

### FIELD

Certain example embodiments are generally related to vacuum insulated devices such as vacuum insulating panels that may be used for windows or the like, and/or methods of making same.

### BACKGROUND AND SUMMARY

Vacuum insulated panels are known in the art. For example, and without limitation, vacuum insulating panels are disclosed in U.S. Pat. Nos. 5,124,185, 5,657,607, 5,664,395, 7,045,181, 7,115,308, 8,821,999, 10,153,389, 11,124,450, 2024/0167320, and 2024/0167324, the disclosures of which are all hereby incorporated herein by reference in their entireties.

As discussed and/or shown in one or more of the above patent documents, a vacuum insulating panel typically includes an outboard substrate, an inboard substrate, a hermetic edge seal, a sorption getter, a pump-out port, and spacers (e.g., pillars) sandwiched between at least the two substrates. The gap between the substrates may be at a pressure less than atmospheric pressure to provide insulating properties. Providing a vacuum in the space between the substrates reduces conduction and convection heat transport, and thus provides insulating properties. For example, a vacuum insulating panel provides thermal insulation resistance by reducing convective energy between the two substrates, reducing conductive energy between the two transparent substrates, and reducing radiative energy with a low-emissivity (low-E) coating provided on one of the substrates. Vacuum insulating panels may be used in window applications (e.g., for commercial and/or residential windows), and/or for other applications such as commercial refrigeration and consumer appliance applications.

Conventional vacuum insulating panels have had problems with seal structures for separate evacuation tubes, leading to breakage and/or cracking of the seal structure thereby losing hermiticity and resulting in pre-mature window failures for example. In certain example embodiments herein, structure(s) and/or method(s) is/are provided to improve evacuation structures, mounting aperture(s), and/or seal(s) therefor.

U.S. Pat. No. 5,664,395 discloses a conventional vacuum insulating panel including a pair of substrates, with a separate pump-out tube inserted into a hole drilled in one of the substrates. Solder glass seal material is provided to seal the joint between the glass substrate and the separate pump-out tube, thereby permanently mounting the separate tube to the substrate. The seal material, which separates the low pressure area from the atmospheric pressure surrounding area, can be prone to failure. Unfortunately, such structures may lead to seal failures, due to the presence of the added seal material provided to seal the joint separating the low pressure area from the atmospheric pressure surrounding area. This can lead to reduced yields and panel failures.

U.S. Patent Document 2022/0127901 discloses a conventional vacuum insulating panel including a pair of substrates, with an evacuation aperture provided in one of the substrates. Following evacuation, adhesive seal material is provided to seal the joint between the glass substrate and a cover the separate pump-out tube. The adhesive seal material, which separates the low pressure area from the atmospheric pressure surrounding area, can be prone to failure. Unfortunately, such structures may lead to seal failures, due to the presence of the added seal material provided to seal the joint separating the low pressure area from the atmospheric pressure surrounding area. This can lead to reduced yields and panel failures.

U.S. Patent Document 2024/0167324 discloses a vacuum insulating panel including a pair of substrates, with a separate permanently mounted evacuation tube provided in one of the substrates. Tellurium oxide inclusive seal material is provided to seal the joint between the glass substrate and the separate pump-out tube. The seal material, which separates the low pressure area from the atmospheric pressure surrounding area, can be prone to failure. Unfortunately, such structures may lead to seal failures, due to the presence of the added seal material provided to seal the joint separating the low pressure area from the atmospheric pressure surrounding area. This can lead to reduced yields and panel failures.

In certain example embodiments herein, structure(s) and/or method(s) is/are provided to improve evacuation structures, mounting aperture(s), and/or seal(s) therefor, in order to improve manufacturing yields and reduce panel failures for example. A vacuum insulating panel may include substrates, a plurality of spacers provided in a gap between substrates, wherein the gap is at pressure less than atmospheric pressure, and an evacuation bore structure for evacuating the gap. In certain example embodiments, the evacuation bore structure may be carved (e.g., carved via laser(s) or otherwise) or otherwise formed into a substrate such as a glass substrate, so that the evacuation bore structure may be formed entirely of material from the substrate itself. Following evacuation, the evacuation bore structure may be sealed (e.g., via laser or otherwise) using material from the bore structure itself (e.g., glass from the substrate itself). Thus, in certain example embodiments, the evacuation bore structure may be configured so that there is no need for any separate tube to be permanently mounted to the substrate and no need for any separate seal material to be added to seal any joint separating the low pressure area from the atmospheric pressure surrounding area. While additional seal material may be used in various example embodiments, it is not required for any joint separating the low pressure area from the surrounding atmospheric pressure area.

In certain example embodiments, there may be provided a vacuum insulating panel comprising: a first glass substrate; a second glass substrate; a plurality of spacers provided in a gap between at least the first and second glass substrates, wherein the gap is at pressure less than atmospheric pressure; an evacuation bore structure comprising glass of the first glass substrate, the evacuation bore structure comprising: an elongated evacuation bore, formed in glass of the first glass substrate, extending away from the gap and exposed to the gap; a tip seal of the bore comprising glass of and/or from the first glass substrate; and a recess formed in the first glass substrate and surrounding the bore as viewed from above, wherein at least part of the bore extends from the gap beyond a base of the recess; wherein the evacuation bore structure does not include any separate evacuation tube permanently mounted to the first substrate.

In certain example embodiments, there may be provided a vacuum insulating panel comprising: a first glass substrate; a second glass substrate; a plurality of spacers provided in a gap between at least the first and second glass substrates, wherein the gap is at pressure less than atmospheric pressure; an evacuation bore structure comprising glass of the first glass substrate, the evacuation bore structure comprising: an evacuation bore, formed in glass of the first glass substrate, extending away from the gap; a tip seal of the bore comprising glass of and/or from the first glass substrate, wherein a top of the tip seal is at elevation below an adjacent major surface of the first glass substrate; a recess formed in the first glass substrate and at least partially surrounding the bore as viewed from above; and a wall separating an interior of the bore from the recess.

In certain example embodiments, there may be provided a vacuum insulating panel comprising: a first substrate (e.g., glass or other suitable material); a second substrate (e.g., glass or other suitable material); a plurality of spacers provided in a gap between at least the first and second substrates, wherein the gap is at pressure less than atmospheric pressure; an evacuation bore structure comprising material of the first substrate, the evacuation bore structure comprising: an evacuation bore, formed in the first substrate, extending away from the gap; a tip seal of the bore comprising material of and/or from the first substrate; and a recess formed in the first substrate and surrounding the bore as viewed from above; wherein the evacuation bore structure does not contain any separate and/or foreign seal material sealing off the gap from an atmospheric pressure area.

In certain example embodiments, there may be provided a vacuum insulating panel comprising: a first glass substrate; a second glass substrate; a plurality of spacers provided in a gap between at least the first and second glass substrates, wherein the gap is at pressure less than atmospheric pressure; an evacuation bore comprising glass; wherein an end portion and/or tip portion of the evacuation bore is sealed to form a tip seal, wherein the tip seal includes a first side comprising a convex surface and a second side comprising a concave surface, the second side located closer to the gap than is the first side, so that the convex surface arcs away from the gap and the concave surface arcs toward the gap.

In certain example embodiments, there may be provided a method of making a vacuum insulating panel comprising a first glass substrate; a second glass substrate; a plurality of spacers provided in a gap between at least the first and second glass substrates; and an evacuation bore structure comprising glass of the first glass substrate; the method comprising: laser carving a recess and an elongated evacuation bore into the first glass substrate, the bore formed in glass of the first glass substrate and extending away from the gap and exposed to the gap, and the recess formed in the glass of the first glass substrate and surrounding the bore as viewed from above; evacuating the gap via the evacuation bore; and after the evacuating of the gap, laser sealing a top and/or tip portion of the bore to form a tip seal of the bore comprising glass of and/or from the first glass substrate; wherein the evacuation bore structure does not include any separate evacuation tube permanently mounted to the first substrate.

In certain example embodiments, there may be provided a vacuum insulating panel comprising: a first glass substrate; a second glass substrate; a plurality of spacers provided in a gap between at least the first and second glass substrates, wherein the gap is at pressure less than atmospheric pressure; an evacuation bore structure comprising glass of the first glass substrate, the evacuation bore structure comprising: an elongated evacuation bore, formed in glass of at least one of the first and second glass substrates, extending away from the gap and exposed to the gap; a tip seal of the bore comprising glass of and/or from at least one of the first and second glass substrates; and a recess formed in at least one of the first and second glass substrates, and surrounding at least part of the bore, wherein at least part of the bore extends from the gap beyond a base of the recess; wherein the evacuation bore structure does not include any separate evacuation tube permanently mounted to the first substrate.

Technical advantage(s), for example, include one or more of: improved evacuation structure hermiticity, improved yields, reduced seal and/or glass breakage or failure, reduced crack formations, improved moisture resistance, improved thermal stability during asymmetric thermal conditions, elimination of manual handling of fragile tubes (e.g., separate glass tubes to be inserted into and permanently mounted to the substrate) resulting in improved yields, faster evacuation, and/or improved durability.

### BRIEF DESCRIPTION OF THE DRAWINGS

These and/or other aspects, features, and/or advantages will become apparent and more readily appreciated from the following description of various example embodiments, taken in conjunction with the accompanying drawings. Thicknesses of layers/elements, and sizes of components/elements, are not necessarily drawn to scale or in actual proportion to one another, but rather are shown as example representations. Like reference numerals may refer to like parts throughout the several views. Each embodiment herein may be used in combination with any other embodiment(s) described herein.

FIG. 1 is a side cross sectional view of a vacuum insulating unit/panel according to an example embodiment.

FIG. 2 is a schematic top view of a vacuum insulating unit/panel according to an example embodiment, showing a laser used in forming the edge seal during manufacturing, which may be used in combination with any embodiment herein including those of FIGS. 1-8.

FIG. 3 is a side cross-sectional view, e.g., taken along section line A-A in FIG. 2, of an evacuation bore structure according to an example embodiment, prior to laser sintering/sealing thereof, which may be used in combination with any embodiment herein including those of FIGS. 1-8.

FIG. 4 is a side cross-sectional view, e.g., taken along section line A-A in FIG. 2, of an evacuation bore structure according to an example embodiment, after evacuation and laser sintering/sealing thereof, which may be used in combination with any embodiment herein including those of FIGS. 1-8.

FIG. 5 is a side cross-sectional view, e.g., taken along section line A-A in FIG. 2, of an evacuation bore structure according to an example embodiment, after evacuation and laser sintering/sealing thereof, which may be used in combination with any embodiment herein including those of FIGS. 1-8.

FIG. 6 is a side cross-sectional view, e.g., taken along section line A-A in FIG. 2, of an evacuation bore structure according to an example embodiment, after evacuation and laser sintering/sealing thereof, which may be used in combination with any embodiment herein including those of FIGS. 1-8.

FIG. 7 is a side cross-sectional view, e.g., taken along section line A-A in FIG. 2, of an evacuation bore structure according to an example embodiment, after evacuation and laser sintering/sealing thereof and with a separate cover added, which may be used in combination with any embodiment herein including those of FIGS. 1-8.

FIG. 8 is a flowchart illustrating example steps in making a vacuum insulating panel according to various example embodiments, which may be used in combination with any embodiment herein including those of FIGS. 1-7.

### DETAILED DESCRIPTION

The following detailed structural and/or functional description(s) is/are provided as examples only, and various alterations and modifications may be made. The example embodiments herein do not limit the disclosure and should be understood to include all changes, equivalents, and replacements within ideas and the technical scope herein. Hereinafter, certain examples will be described in detail with reference to the accompanying drawings. When describing various example embodiments with reference to the accompanying drawings, like reference numerals may refer to like components and a repeated description related thereto may be omitted.

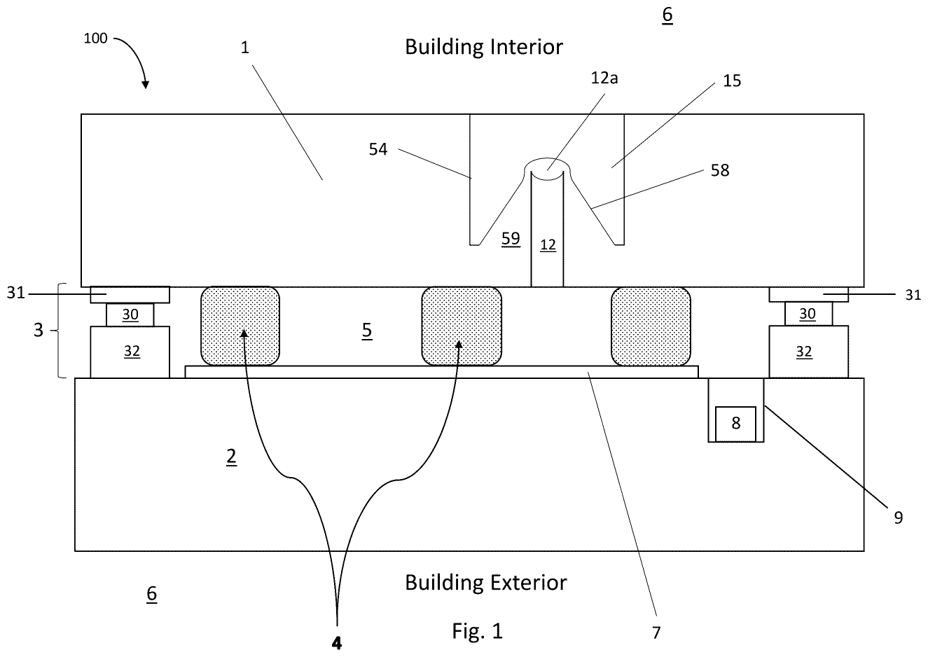

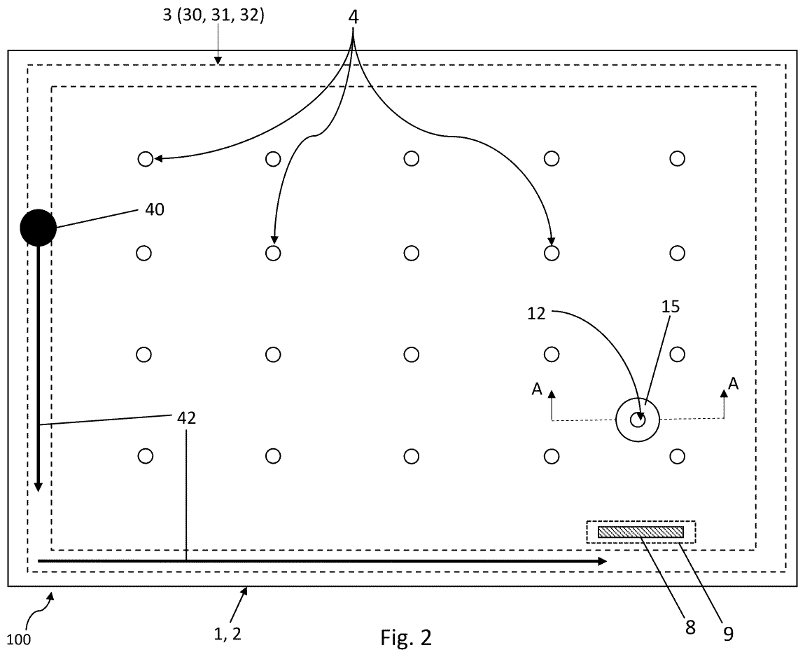

FIG. 1 is a side cross sectional view illustrating a vacuum insulating panel 100 according to various example embodiments, and FIG. 2 is a schematic top view of an example vacuum insulating unit/panel 100 showing a laser beam 40 being used in sintering/firing the main seal layer 30 when forming the edge seal 3 during manufacturing (which may be used in combination with any embodiment herein). It should be noted that, in practice, such vacuum insulating panels/units may be oriented upside down or sideways from the orientations illustrated in FIGS. 1-2. Vacuum insulating panel 100 may be used in window applications (e.g., for commercial and/or residential windows), and/or for other applications such as commercial refrigeration and consumer appliance applications.

Referring to FIGS. 1-2, a vacuum insulating panel 100 may include at least a first substrate 1 (e.g., glass substrate), a second substrate 2 (e.g., glass substrate), a hermetic edge seal 3 at least partially provided proximate the edge of the panel 100, and a plurality (e.g., an array) of spacers 4 provided between at least the substrates 1 and 2 for spacing the substrates from each other and so as to help provide low-pressure space/gap 5 between at least the substrates. Each glass substrate 1, 2 may be flat, or substantially flat, possibly with non-uniform surface features from thermal heat treatment of the glass, in certain example embodiments. Support spacers 4, sometimes referred to as pillars, may be of any suitable shape (e.g., round, oval, disc-shaped, square, rectangular, rod-shaped, etc.) and may be of or include any suitable material such as stainless steel, aluminum, ceramic, solder glass, metal, and/or glass. Certain example support spacers 4 shown in the figures are substantially circular as viewed from above and substantially rectangular as viewed in cross section, and may have rounded edges. The hermetic edge seal 3 may include one or more of main seal layer 30, upper primer layer 31, and lower primer layer 32. Each “layer” herein may comprise one or more layers. At least one thermal control and/or solar control coating 7, such as a multi-layer low-emittance (low-E) coating, may be provided on at least one of the substrates 1 and 2 in order to further improve insulating properties of the panel. The solar control coating 7 may be provided on substrate 1 or substrate 2, or such a solar control coating may be provided on both substrates 1 and 2. For example, FIG. 1 illustrates such a coating 7 (e.g., low-E coating) provided on substrate 2, whereas in other example embodiments the coating 7 may be provided on substrate 1. Each substrate 1 and 2 is preferably of or including glass, but may instead be of other material such as plastic or quartz. For example, one or both glass substrates 1 and 2 may be soda-lime-silica based glass substrates, borosilicate glass substrates, lithia aluminosilicate glass substrates, or the like, and may be clear, low iron, or otherwise tinted/colored such as green, grey, bronze, or blue tinted. Substrates 1 and 2, in certain example embodiments, may each have a visible transmission of at least about 40%, more preferably of at least about 50%, and most preferably of from about 60-90%. The vacuum insulating panel 100, in certain example embodiments, may have a visible transmission of at least 40%, more preferably of at least 50%, and most preferably of at least 60%. The substrates 1 and 2 may be substantially parallel (parallel plus/minus ten degrees, more preferably plus/minus five degrees) to each other in certain example embodiments. Substrates 1 and 2 may or may not have the same thickness, and may or may not be of the same size and/or same material, in various example embodiments. When glass is used for substrates 1 and 2, each of the glass substrates may be from about 1-12 mm thick, more preferably from about 2-12 mm thick, more preferably from about 3-8 mm thick, and most preferably from about 4-6 mm thick. When glass is used for substrates 1 and 2, the glass may or may not be tempered (e.g., thermally tempered). Although thermally tempered glass substrates are desirable in certain environments, the glass substrate(s) may be annealed or heat strengthened. As known in the art, thermal tempering of soda-lime-silicate based glass for example typically involves heating the glass to a temperature of at least 585 degrees C., more preferably to at least 600 degrees C., more preferably to at least 620 degrees C. (e.g., to a temperature of from about 620-650 degrees C.), and then rapidly cooling the heated glass so as to compress surface regions of the glass to make it stronger. The glass substrates may be thermally tempered to increase compressive surface stress and/or central tension stress, and to impart safety glass properties including small fragmentation upon breakage. When tempered glass substrates 1 and/or 2 are used, the substrate(s) may be tempered (e.g., thermally or chemically tempered) prior to firing/sintering of main edge seal material 30 (e.g., via laser) to form the edge seal 3.

When heat strengthened glass substrates 1 and/or 2 are used, the substrate(s) may be heat strengthened prior to firing/sintering of the main edge seal material 30 (e.g., via laser) to form the edge seal 3. When a vacuum insulated glass panel/unit has one tempered glass substrate and one heat strengthened substrate, the substrate(s) may be tempered (e.g., thermally or chemically tempered) and heat strengthened prior to firing/sintering of the main edge seal material 30 (e.g., via laser) to form the edge seal 3.

In various example embodiments, each vacuum insulating panel 100, still referring to FIGS. 1-2, optionally may also include at least one sorption getter 8 (e.g., at least one thin film getter) for helping to maintain the vacuum in low pressure space 5 by using reactive material for soaking up and/or bonding to gas molecules that remain in space 5, thus providing for sorption of gas molecules in low pressure space 5. The getter 8 may be provided directly on either glass substrate 1 or 2, or may be provided on a low-E coating 7 in certain example embodiments. In certain example embodiments, the getter 8 may be laser-activated and/or activated using inductive heating techniques, and/or may be positioned in a trough/recess 9 that may be formed in the supporting substrate (e.g., substrate 2) via laser etching, laser ablating, and/or mechanical drilling.

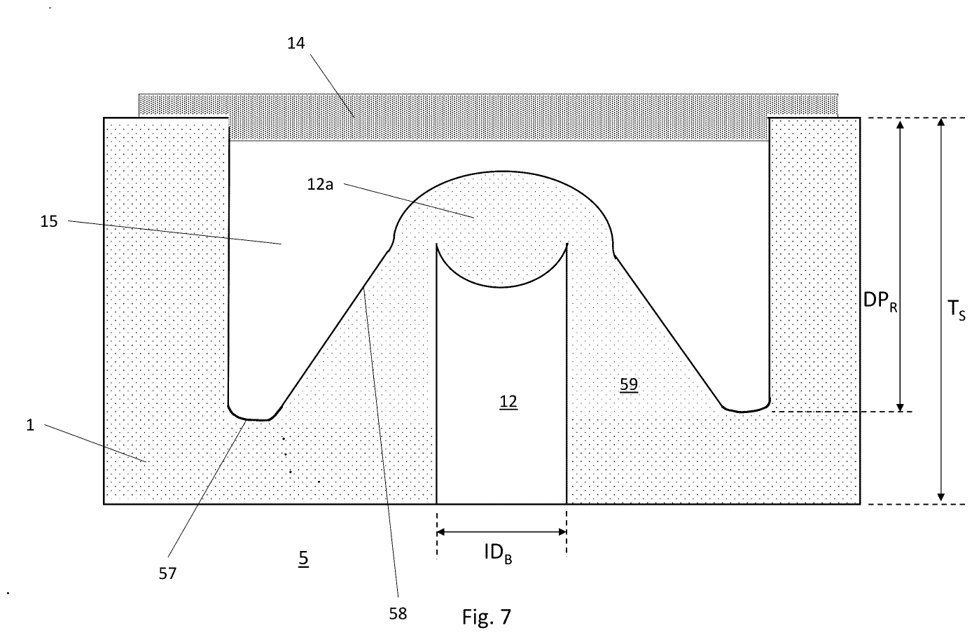

Referring to FIGS. 1-8, in certain example embodiments herein, structure(s) and/or method(s) is/are provided to improve evacuation structures, mounting aperture(s), and/or seal(s) therefor, in order to improve manufacturing yields and reduce panel failures for example. Vacuum insulating panel 100 may include substrates 1, 2, a plurality of spacers 4 provided in a gap between substrates, wherein the gap 5 is at pressure less than atmospheric pressure, and an evacuation bore structure (e.g., 12, 15) for evacuating the gap. In certain example embodiments, the evacuation bore structure, including a protruding evacuation bore 12, may be carved (e.g., carved via laser(s) or otherwise) or otherwise formed into substrate 1 which may be a glass or quartz substrate for instance. Thus, the evacuation bore structure may be integral with the glass substrate 1 and made entirely or substantially entirely of material from substrate 1, with no separate permanently mounted evacuation tube needed. Following evacuation, a top portion of the evacuation bore 12 may be sealed at 12a (e.g., via laser sealing or otherwise) using material from the bore structure itself (e.g., glass from the substrate 1 itself). Thus, in certain example embodiments, the evacuation bore structure may be configured so that there is no need for any separate evacuation tube to be inserted into and permanently mounted to the substrate 1 via foreign seal material, no need for any separate/foreign seal material to be added to seal any joint separating the low pressure area 5 from the atmospheric pressure area 6 surrounding the panel, and no need for any separate/foreign sealing plug for sealing the bore 12. While additional seal material may be used in various example embodiments (e.g., to attach a cover 14), it is not required for any joint separating the low pressure area 5 from the surrounding atmospheric pressure area 6. The evacuation (e.g., pump-out) bore structure may be used at least for evacuating the space 5 to a pressure(s) less than atmospheric pressure, where the top and/or tip portion of the elongated evacuation bore 12 may be closed/sealed (e.g., via laser sealing) after evacuation of the space 5. Optionally, a cover 14 (e.g., see FIG. 7) may be provided over the bore 12 after it is sealed, and sealing material may be provided between the cover 14 and the substrate 1 to maintain the cover in position. A low-profile cover 14 may be advantageous, for example, in allowing the panel to more easily pass through commercial washers and/or to realize improved durability Evacuation bore 12 may be located at any suitable location of the panel. Because the evacuation bore structure is carved or otherwise formed into the substrate 1 itself, no separate permanently mounted pump-out tube is needed (i.e., no separate metal or glass pump-out tube needs to be inserted into any substrate and permanently mounted thereto). And because there is no separate pump-out tube which is inserted into and permanently mounted to the substrate, there is no need for any separate/foreign seal material to be added to seal any joint separating the low pressure area 5 from the atmospheric pressure surrounding area 6. These allow for one or more of the technical advantages discussed herein to be realized.

In certain example embodiments, the evacuation bore structure (e.g., 12, 15) may be located on the side of the vacuum insulating panel 100 configured to face the interior of the building when the panel is used in a commercial and/or residential window (e.g., see FIG. 1). However, in certain example embodiments, the evacuation bore structure may instead be located on the side of the vacuum insulating panel 100, e.g., in substrate 2, configured to face the exterior of the building.

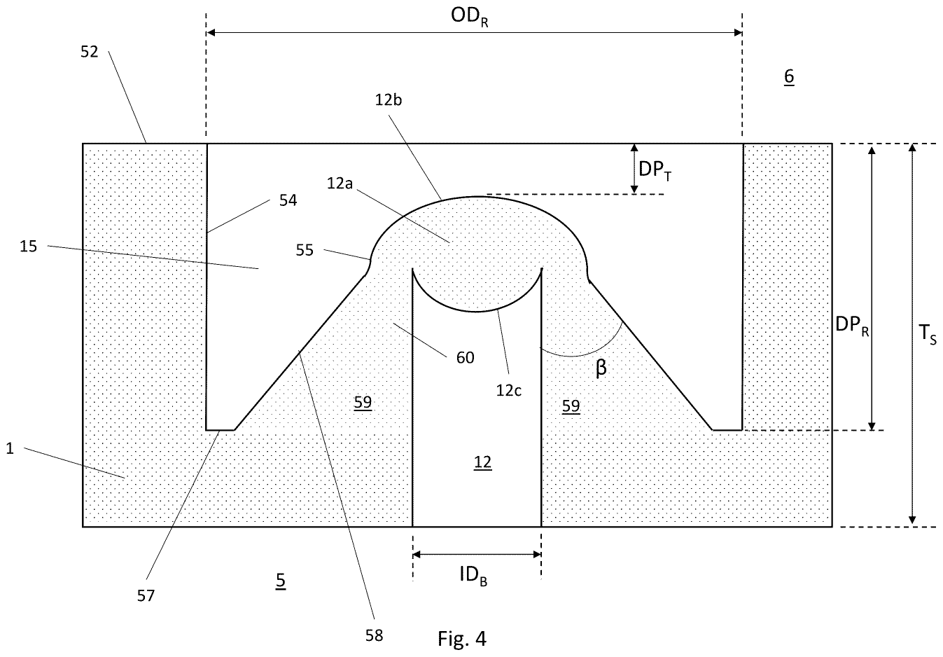

After evacuation of gap/space 5 via open bore 12, the top and/or tip portion of the bore 12 may be melted via laser to seal same at 12a (e.g., to form a laser fused glass dome 12a at the top of the bore, using material of the substrate 1 itself, as shown in FIGS. 4-7), and hermetic sealing of the space 5 in the panel 100 can be provided both by the edge seal 3 and by the sealed upper portion 12a of the evacuation/pump-out bore 12. In certain example embodiments, as shown in FIGS. 1-7 for example, the elongated evacuation bore 12 may be substantially perpendicular (perpendicular plus/minus ten degrees, more preferably plus/minus five degrees) to major surface(s) of the substrates 1 and 2. Any of the elements/components shown in FIGS. 1-8 may be omitted in various example embodiments.

The evacuated gap/space 5 between the substrates 1 and 2, in the vacuum insulating panel 100, is at a pressure less than atmospheric pressure. For example, after the edge seal 3 has been formed, the cavity 5 evacuated to a pressure less than atmospheric pressure, and the pump-out bore 12 closed/sealed, the gap 5 between at least the substrates 1 and 2 may be at a pressure no greater than about 1.0×10⁻² Torr, more preferably no greater than about 1.0×10⁻³ Torr, more preferably no greater than about 1.0×10⁻⁴ Torr, more preferably no greater than about 1.0×10⁻⁵ Torr, and for example may be evacuated to a pressure no greater than about 1.0∴10⁻⁶ Torr. The gap 5 may be at least partially filled with an inert gas in various example embodiments. In certain example embodiments, the evacuated vacuum gap/space 5 may have a thickness (in a direction perpendicular to planes of the substrates 1 and 2) of from about 100-1,000 μm, more preferably from about 200-500 μm, and most preferably from about 230-350 μm. Providing a vacuum in the gap/space 5 is advantageous as it reduces conduction and convection heat transport, so as to reduce temperature fluctuations inside buildings and the like, thereby reducing energy costs and needs to heat and/or cool buildings. Thus, panels 100 can provide high levels of thermal insulation.

Example low-emittance (low-E) coatings 7 which may be used in the vacuum insulating panel 100 are described in U.S. Pat. Nos. 5,935,702, 6,042,934, 6,322,881, 7,314,668, 7,342,716, 7,632,571, 7,858,193, 7,910,229, 8,951,617, 9,215,760, and 10,759,693, the disclosures of which are all hereby incorporated herein by reference in their entireties. Other low-E coatings may also, or instead, be used. A low-E coating 7 typically includes at least one IR reflecting layer (e.g., of or including silver, gold, or the like) sandwiched between at least first and second dielectric layer(s) of or including materials such as silicon nitride, zinc oxide, zinc stannate, and/or the like. The low-E coating 7, for example, may include one, two, or three of such IR reflecting layers in various example embodiments. A low-E coating 7 may have one or more of: (i) a hemispherical emissivity/emittance of no greater than about 0.20, more preferably no greater than about 0.04, more preferably no greater than about 0.028, and most preferably no greater than about 0.015, and/or (ii) a sheet resistance (R_{S}) of no greater than about 15 ohms/square, more preferably no greater than about 2 ohms/square, and most preferably no greater than about 0.7 ohms/square, so as to provide for solar control. In certain example embodiments, the low-E coating 7 may be provided on the interior surface of the glass substrate to be closest to the building exterior, which is considered surface two (e.g., see FIG. 1), whereas in other example embodiments the low-E coating 7 may be provided on the interior surface of the glass substrate to be closest to the building interior, which is considered surface three.

FIG. 1 illustrates an embodiment where the edge seal 3 is spaced inwardly from the absolute edge of the panel 100, the width of the main seal layer 30 is less than a width(s) of the primer layers 31 and 32, and a thickness of the main seal layer 30 is greater than a thickness of primer layer 31 but less than a thickness of the other primer layer 32. However, the thicknesses and location of the edge seal layer(s) may be modified in various alternative embodiments. For example, layers 30-32 may each be approximately the same thickness in various example embodiments, and/or one or more of layers 31 and/or 32 may be omitted in various example embodiments. In certain example embodiments, a laser beam 40 from a laser may be used to heat the edge seal structure for sintering/firing the main seal layer 30 to form the hermetic edge seal 3. FIG. 2 is a top view illustrating the laser beam 40 proceeding around the entire periphery of the panel along path 42 over the edge seal layers 30-32 to fire/sinter the main edge seal layer 30 in forming the hermetic edge seal 3. The laser beam 40 performs localized heating of the edge seal area, so as to not unduly heat certain other areas of the panel thereby reducing chances of significant de-tempering of the glass substrates. Each of these embodiments may be used in combination with any other embodiment described herein, in whole or in part.

Edge seal 3, which may include one or more of ceramic layers 30-32, may be located proximate the periphery or edge of the vacuum insulated panel 100 as shown in FIGS. 1-2. Edge seal 3 may be a ceramic edge seal in certain example embodiments. Referring to FIGS. 1-2, in certain example embodiments, layer 30 of the edge seal may be considered a main or primary seal layer, and layers 31 and 32 may be considered primer layers. One or more of seal layers 30-32, of the edge seal 3, may be of or include ceramic frit in certain example embodiments, and/or may be lead-free or substantially lead-free (e.g., no more than about 15 ppm Pb, more preferably no more than about 5 ppm Pb, even more preferably no more than about 2 ppm Pb) in certain example embodiments. In certain example embodiments, each primer layer 31 and 32 may be of a material having a coefficient of thermal expansion (CTE) that is between that of the main seal layer 30 and the closest glass substrate 1, 2. A primer(s) 31 and/or 32 may be omitted in certain example embodiments. In certain example embodiments, primer layers 31 and 32 may be of or include different material(s) compared to the main seal layer 30.

The edge seal 3, in certain example embodiments, may be located at an edge-deleted area (where the solar control coating 7 has been removed) of the substrate as shown in FIGS. 1-2, so as to reduce chances of corrosion. Thus, the edge seal 3 may be positioned so that it does not overlap the low-E coating 7 in certain example embodiments. The edge seal 3 may be located at the absolute edge of the panel 100 (e.g., FIG. 1), or may be spaced inwardly from the absolute edge of the panel 100 as shown in FIGS. 1-2, in different example embodiments. An outer edge of the hermetic edge seal 3 may be located within about 50 mm, more preferably within about 25 mm, and more preferably within about 15 mm, of an outer edge of at least one of the substrates 1 and/or 2. Thus, an “edge” seal does not necessarily mean that the edge seal 3 is located at the absolute edge or absolute periphery of a substrate(s) or overall panel 100.

The low-E coating 7 may be edge deleted around the periphery of the entire unit so as to remove the low-e coating material from the coated glass substrate. The low-E coating 7 edge deletion width (edge of glass to edge of low-E coating 7), in certain example embodiments, in at least one area may be from about 0-100 mm, with examples being no greater than about 6 mm, no greater than about 10 mm, no greater than about 13 mm, no greater than about 25 mm, with an example being about 16 mm. In certain example embodiments, there may be a gap between the primer seal layers 31 and 32 and/or main layer 30, and the low-E coating 7, of at least about 1.0 mm, and/or of at least about 0.5 mm, so that the low-E coating 7 is not contiguous with the main seal layer 30 and/or the primer seal layers 31 and 32.

Referring to FIGS. 1-2 for example, in the manufactured vacuum insulating panel 100, the main seal layer 30 of the edge seal 3 may have an average thickness of from about 30-180 μm, more preferably from about 30-120 μm, more preferably from about 40-100 μm, and most preferably from about 50-85 μm, with an example main seal layer 30 average thickness being from about 60-80 μm. In certain example embodiments, in the manufactured vacuum insulating panel 100, the primer layer 31 of the edge seal 3 may have an average thickness of from about 10-100 μm, more preferably from about 10-80 μm, more preferably from about 20-70 μm, and most preferably from about 20-55 μm, with an example primer layer 31 average thickness being about 45 μm. In certain example embodiments, in the manufactured vacuum insulating panel 100, the primer layer 32 (opposite the side from which the laser beam 40 is directed) of the edge seal 3 may have an average thickness of from about 80-240 μm, more preferably from about 100-220 μm, more preferably from about 120-200 μm, and most preferably from about 120-170 μm, with an example primer layer 32 average thickness being about 145 μm. In certain example embodiments, the respective thicknesses of each layer 30, 31, and 32 are substantially the same (the same plus/minus 10%, more preferably plus/minus 5%) along the length of the edge seal 3 around the periphery of the entire panel 100.

Seal layer 30 may be of or include tellurium oxide or other suitable material in certain example embodiments, and one or both of seal layers 31-32 may be of or include bismuth oxide and/or boron oxide, or other suitable material, in various example embodiments. Further example details of the edge seal structure, example dimensions of the edge seal 3, 30, 31, 32, example materials for the edge seal layer(s), and other components, characteristics of the edge seal and other components, materials, and the manufacture of the overall panel may be provided in one or more of U.S. Patent Document/Application Serial Nos. 2024/0167324, 2024/0167320, Ser. No. 18/376,914, Ser. No. 18/376,473, Ser. No. 18/376,479, Ser. No. 18/376,483, Ser. No. 18/379,275, and Ser. No. 18/510,777, the disclosures of which are all hereby incorporated herein by reference in their entireties.

In various example embodiments, a laser beam 40 having a wavelength (λ) of from about 380 nm to 1064 nm, more preferably from about 550 nm to 1064 nm, more preferably from about 780-1064 nm, may be used to fire the main seal layer 30, and the laser for same in certain example embodiments may be a continuous wave laser, a pulsed laser, and/or other suitable laser in various example embodiments. In various example embodiments, the laser to be used for firing/sintering the seal layer 30 may be a scanning laser system comprising diode laser, solid state laser (e.g., ND:YAG), gas laser (e.g., CO₂ of 9.3-10.6 μm), and/or other laser devices/sources. In certain example embodiments, laser beam 40 may be emitted so as to have a wavelength of about 800 nm, 808 nm, 810 nm, 940 nm, or 1090 nm (e.g., YVO4 laser). For example, 808 nm or 810 nm diode lasers; or 914 nm, 940 nm, 1064 nm, or 1342 nm solid state lasers (e.g., YVO4 lasers). In certain example embodiments, more than one laser may be utilized to increase the sealing speed for seal material 30, lower effective laser power levels and/or reduce laser spot size.

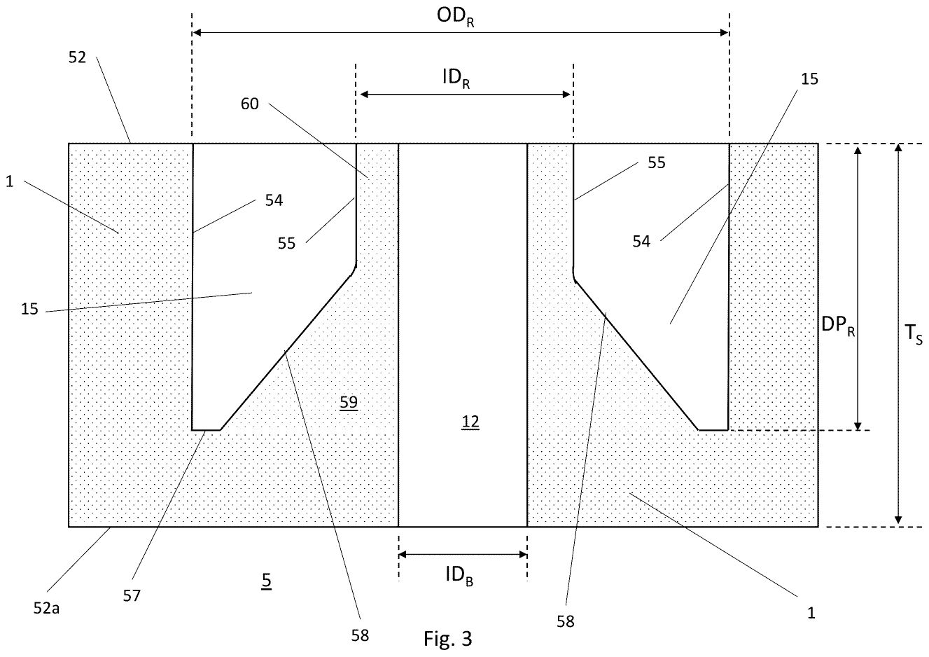

FIG. 3 is a side cross-sectional view, e.g., taken along section line A-A in FIG. 2, of an evacuation bore structure according to an example embodiment, prior to evacuation and thus prior to sealing thereof, which may be used in combination with any embodiment herein including those of FIGS. 1-8. FIG. 3 illustrates a portion of substrate 1 in an intermediate point in the manufacturing process, as the evacuation bore structure is being formed in substrate 1, but before evacuation and thus before the tip of the bore 12 is sealed. The evacuation bore structure, which may include bore 12 and recess 15, may be integral with the glass substrate 1.

In certain example embodiments, a first laser may be used to form recess 15 in substrate 1 via laser ablation or in any other suitable manner. Recess 15 may, for example, be annular and/or circular in shape as viewed from above (e.g., see FIGS. 1-3), or may be any other suitable shape as viewed from above such as square, oval, rectangular, or the like. In certain example embodiments, recess 15 may have an outer size (e.g., outer diameter and/or width) OD_{R} of from about 4-10 mm, more preferably from about 4.5 to 9 mm, with examples being about 5 mm, about 7 mm, or about 9 mm. In certain example embodiments, OD_{R} may be sufficiently sized so as to be not influenced, or not be influenced to a significant or detrimental extent, by the laser tip sealing process. In certain example embodiments, at least part of recess 15 may have an inner size (e.g., inner diameter and/or width) ID_{R} of from about 2-8 mm, more preferably from about 3 to 7 mm, more preferably from about 3.5 to 6.5 mm, with examples being about 3 mm, about 4 mm, or about 5 mm for ID_{R} as viewed from above and/or below, for at least one location in its length. Bore wall 60, for at least one location along its vertical length, may have a wall thickness D_{W} of at least about 0.4 mm, more preferably of at least about 0.5 mm, possibly of at least about 0.6 mm, for strength of the structure.

In certain example embodiments, a ratio OD_{R}/ID_{R} for recess 15 may be from about 1.3 to 2.3, more preferably from about 1.4 to 2.1, more preferably from about 1.5 to 1.9, with an example being about 1.7 or about 1.8. In certain example embodiments, recess 15 may have a depth DP_{R}, measured from major surface 52 of substrate 1, of from about 1-6 mm, more preferably from about 2-5 mm, more preferably from about 2-4 mm, and for example about 3 mm. In certain example embodiments, depth DP_{R} of the recess 15 may be designed to be as shallow as reasonable for strength of the overall structure, but deep enough to avoid or reduce glass fractures during sealing. In certain example embodiments, T_{S}-DP_{R} may be at least about 2.0 mm, and/or a ratio DP_{R}/T_{S} may be no greater than about 0.67, more preferably no greater than about 0.60, more preferably no greater than about 0.55, and possibly no greater than about 0.50 or no greater than about 0.47. In certain example embodiments, recess 15 may have a depth DP_{R} that is from about 40-75%, more preferably from about 45-70%, and most preferably from about 47-67%, of the overall thickness T_{S} of the substrate 1. For example, if a glass substrate 1 is about 4.7 mm or 4.8 mm thick (T_{S}), then the recess 15 may be about 3.0 mm deep or about 2.5 mm deep (DP_{R}). In certain example embodiments, DP_{R}>=DP_{T}+D_{T}.

Still referring to FIG. 3, in certain example embodiments recess 15 may be formed to have an outer sidewall 54 and/or an inner sidewall 55. The entirety, or part of, outer sidewall 54 may be vertical or substantially vertical in certain example embodiments. Thus, in certain example embodiments, the entirety or part of outer sidewall 54 of recess 15 may be perpendicular or substantially perpendicular to major surface 52 of substrate 1. The entirety, or part of, inner sidewall 55 may be vertical or substantially vertical in certain example embodiments. Thus, in certain example embodiments, the entirety or part of optional inner sidewall 55 of recess 15 may be perpendicular or substantially perpendicular to major surface 52 of substrate 1. As shown in FIG. 3, in certain example embodiments at least parts of inner and outer sidewalls 54, 55 of the recess 15 may be substantially parallel to each other in certain example embodiments. Recess 15 may also include a base 57, at least part of which may be substantially parallel to major surfaces 52 and 52a of substrate 1 in certain example embodiments. Base 57 may be flat, U-shaped, or shaped in any other suitable manner in various example embodiments. In certain example embodiments, the width of recess base 57 on a given side of the bore 12 may be from about 5-60%, more preferably from about 10-50%, and more preferably from about 10-30%, of the overall width of the recess 15 on that side of the bore 12 (e.g., see FIGS. 1, 3-7), for example due to the presence of angled sidewall 58.

Recess 15 may include an angled wall 58 in certain example embodiments which may connect base 57 to inner sidewall 55, and/or which may connect the base 57 to the sealed upper portion 12a of the bore 12. Angled sidewall 58 may be formed so as to be continuously sloped as shown in FIG. 3, or may be formed to be sloped in a step-like manner via a plurality of steps progressing up/down the sidewall. In other words, for example, angled sidewall 58 may take the form of a substantially straight line as shown in FIG. 3, or alternatively may take the form of a plurality of steps which overall form the slope of angled sidewall. Referring to FIGS. 1-7, in certain example embodiments, at least part of angled sidewall 58 may form an angle β of from about 10-70 degrees, more preferably from about 20-70 degrees, more preferably from about 30-60 degrees, more preferably from about 40-50 degrees, with an adjacent wall of bore 12. The thicker substrate area 59 proximate the lower portion of bore 12, due to angled sidewall 58, functions to provide additional strength and durability to the overall bore structure.

In certain example embodiments, vertical sidewall 55 may be very short or omitted, and angled sidewall 58 may extend (at the same or progressively varying angles) from base 57 to or almost to the sealed tip portion 12a of the bore structure (e.g., see FIGS. 1, 4-7).

Still referring to FIG. 3, in certain example embodiments, after recess 15 is formed in substrate 1, evacuation bore 12 may be drilled (e.g., laser drilled) in the substrate 1. Since the evacuation bore structure (e.g., 12, 15) is formed entirely of material from the substrate 1 itself (e.g., from glass of the substrate 1), this may be referred to as a tube-in-glass (TIG) design. Referring to FIG. 3 for example, substantially cylindrical evacuation bore 12 preferably extends all the way through the depth/thickness of the substrate 1 in certain example embodiments, and thus has a depth T_{S} prior to sealing thereof. Thus, recess 15 preferably surrounds bore 12 as viewed from above, with wall 60 provided between an interior of the bore 12 and recess 15, and the bore 12 protruding upwardly from a base of the recess (e.g., see FIGS. 1-7). While protruding evacuation bore 12 is preferably formed in substrate 1 after recess 15 is formed, it is possible to form bore 12 through the substrate 1 prior to the formation of recess 15 in various other example embodiments. While bore 12 is shown as being formed in substrate 1, it would be possible to instead form the evacuation bore structure in substrate 2 in alternative embodiments. As viewed from above, evacuation bore 12 may be substantially circular or annular in shape (e.g., see FIGS. 2-3), but could also be otherwise shaped as viewed from above such as square, rectangular, or oval shaped. Bore 12 may be oriented substantially perpendicular to major substrate surface 52 as shown in FIG. 3 in certain example embodiments, but alternatively may be formed at an angle so as to extend at an angle into at least one of the substrate 1 and/or 2. Bore 12 and/or recess 15 may be formed in at least one of substrate 1 and/or substrate 2. Referring to FIG. 3, in certain example embodiments, prior to evacuation and thus prior to the bore tip being sealed at 12a, the evacuation bore 12 may extend to an elevation substantially the same as the elevation of major surface 52 of substrate 1.

In certain example embodiments, at least part of elongated bore 12 may have an inner size (e.g., diameter and/or width) ID_{B} as viewed from above and/or below of from about 1-6 mm, more preferably from about 1.5 to 5 mm, more preferably from about 2 to 4.5 mm, with examples being about 2.2 mm, about 3 mm, or about 4 mm for ID_{B} as viewed from above and/or below, for at least one location in its length. In certain example embodiments it may be desirable for ID_{B} to be large to increase conductance. In certain example embodiments, the size (e.g., diameter and/or width) ID_{B} of bore 12 may be substantially constant throughout its length, but in other embodiments it is possible for ID_{B} of bore 12 to gradually and/or progressively change throughout the depth of the bore. For example, the ID_{B} of bore 12 may become gradually and/or progressively narrower/smaller moving toward low pressure space 5 in certain example embodiments. In certain example embodiments, a ratio OD_{R}/ID_{B} may be from about 1.5 to 4.3, more preferably from about 1.7 to 4.0, more preferably from about 2.0 to 3.5. In certain example embodiments, a ratio of bore length to bore size (T_{S}/ID_{B}) before and/or after bore sealing may be at least about 1.0, more preferably at least about 1.5. In certain example embodiments, a ratio of bore length to bore size (T_{S}/ID_{B}) may be from about 1.0 to 4.0, more preferably from about 1.5 to 3.0. Regarding the wall thickness D_{W} of at least part of bore 12, in certain example embodiments ID_{R}-ID_{B} may be from about 0.4 to 2.0 mm, more preferably from about 0.4 to 1.0 mm, more preferably from about 0.4 to 0.7 mm,, with examples being about 0.4 mm or about 0.5 mm.

Still referring to FIG. 3, in certain example embodiments, the laser(s) used to form recess 15 and bore 12 in substrate 1 (e.g., glass or quartz substrate) via laser ablation or otherwise may be any suitable form of laser. In various example embodiments, the laser used to form recess 15 and bore 12 in the substrate 1 may be a scanning laser system comprising a diode laser, a pulsed blue or green laser, solid state laser (e.g., ND:YAG), gas laser (e.g., CO₂ of 9.3-10.6 μm), UV laser (e.g., 3^{rd} harmonics of YAG type crystals, such as about 355 nm), and/or other suitable laser devices/sources. In certain example embodiments, a pulsed laser beam used to form recess 15 and/or bore 12 may be emitted so as to have a wavelength of about 532 mm, 800 nm, 808 nm, 810 nm, 940 nm, or 1090 nm (e.g., YVO4 laser). In such a manner, the recess 15 and bore 12 may be carved into substrate 1, via laser or in any other suitable manner, so that the evacuation bore structure (e.g., 12, 15) may be formed entirely or substantially entirely from material of the substrate 1 itself.

Space 5 between the substrates 1, 2 may be evacuated to pressure less than atmospheric pressure, using the open bore 12 shown in FIG. 3. Air/gas may be sucked/vacuumed out of space 5 via the open bore 12, and/or the panel may be placed in a vacuum space to implement same. After the space 5 has been evacuated to pressure less than atmospheric pressure in such a manner(s), the upper and/or tip portion of bore is sealed at 12a (e.g., see FIGS. 1, 4-6), such as via laser sealing for causing the material (e.g., glass) of the substrate 1 and thus the bore structure to melt onto itself to form the tip seal at 12a.

FIG. 4 illustrates the evacuation bore structure of FIG. 3, after the low pressure space 5 has been evacuated and the bore tip has thereafter been sealed at 12a according to an example embodiment. Thus, as shown in FIG. 4, the bore tip seal 12a, using material from the substrate 1 itself, seals off the low pressure space 5 from at least the surrounding atmospheric pressure area 6. In certain example embodiments, a laser is used to seal the upper and/or tip portion of the bore at 12a (e.g., see FIGS. 1, 4-6) in a manner for causing the material (e.g., glass) of the substrate 1 and thus the bore structure itself to melt onto itself to form the tip seal at 12a. Because the laser may cause the material of the bore structure itself (of the substrate 1 itself) to melt onto itself in forming the tip seal 12a, after formation of the tip seal the top of the tip seal 12a may be at a lower elevation such as at an elevation DP_{T} of from about 0.3 to 1.7 mm (more preferably from about 0.3 to 1.5 mm, more preferably from about 0.4 to 1.2 mm, more preferably from about 0.5 to 0.8 mm, with an example being about 0.7 mm) below the major surface 52 of substrate 1. Thus, in certain example embodiments, sealing of the bore tip may cause the top of the bore 12 to drop from an elevation proximate major surface 52 to an elevation below major surface 52 of the substrate 1, for example as shown in FIG. 4 (see also FIGS. 1, 5-7). In certain example embodiments, ratio DP_{T}/T_{S} may be from about 0.05 to 0.40, more preferably from about 0.08 to 0.30, more preferably from about 0.10 to 0.25, more preferably from about 0.10 to 0.20, with an example being about 0.14. In certain example embodiments, ratio DP_{T}/DP_{R} may be from about 0.10 to 0.40, more preferably from about 0.15 to 0.35, more preferably from about 0.17 to 0.30, with an example being about 0.23 or about 0.30.

In the past, many have attempted to use inductive heat to close/seal the tip of evacuation tubes in making vacuum panels. Such attempts have resulted in one or more of: a lack or durability for the final product, pre-mature seal failures, and/or sagging/slumping of the glass at the top of the tube to form a concave upper tube end in a manner which can lead to durability issues.

In certain example embodiments, these problems may be addressed by at least one of: eliminating the need for a separate evacuation tube to be permanently sealed to and thus permanently mounted on the substrate 1 as discussed herein, and using an appropriate laser for sealing the elongated bore 12 to form tip/bore seal 12a in an efficient and durable manner. In certain example embodiments, a laser may be used to seal the upper end of the bore in a fast and efficient manner which may result in a substantially dome-shaped upper tip seal 12a which may comprise a convex upper surface 12b and a substantially controlled thickness, and which is durable and can reduce premature seal failures. In certain example embodiments, a different laser may be used to form bore tip seal 12a. For example, in certain example embodiments, a gas laser (e.g., CO₂ or other suitable laser for emitting laser beam having wavelength of from about 5-12 μm, more preferably from about 7-11 μm, more preferably from about 9-11 μm, with an example being in a range of from about of 9.3-10.6 μm) may be used to form tip seal 12a using the material of substrate 1. In certain example embodiments, a UV laser may be used to form tip seal 12a.

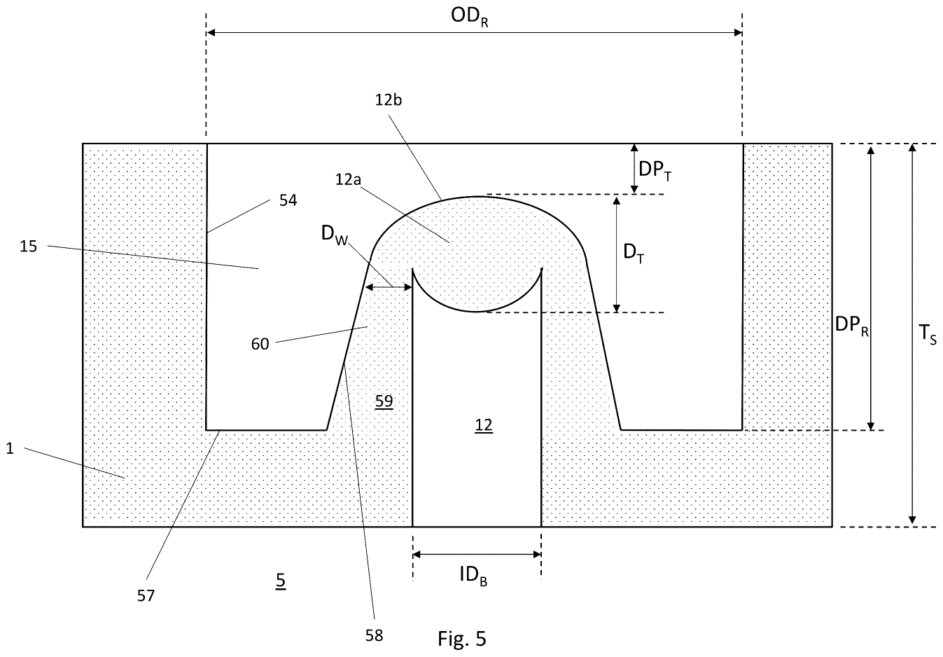

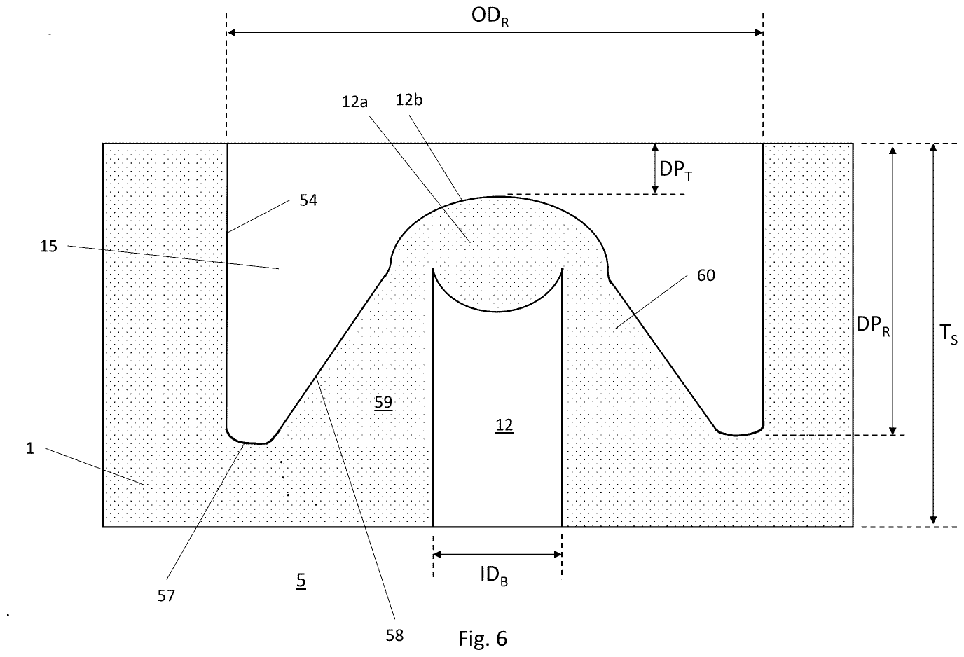

While FIG. 4 illustrates the evacuation bore structure of FIG. 3 after the low pressure space 5 has been evacuated and the bore tip has thereafter been sealed at 12a according to an example embodiment, FIGS. 5-7 illustrate other example embodiments. The descriptions above regarding FIGS. 1-4 also apply to FIGS. 5-7 with respect to like parts, as FIGS. 5-7 differ from FIG. 4 with respect to dimensional and/or shape changes for instance. For example, recess 15 in FIG. 5 has a steeper angled sidewall 58 and a wider base 57 compared to FIG. 4. As another example, the FIG. 6 embodiment has a substantially U-shaped recess base 57, and vertical sidewall 55 is not present, compared to FIG. 4. As another example, the FIG. 7 embodiment is essentially the FIG. 6 embodiment, except that low-profile cover 14 has been added to cover the bore tip seal 12a and protect same during things such as handling, shipping, and/or washing. Cover 14 may be applied to any embodiment herein, and may be attached to the substrate 1 via sealing material and/or adhesive (e.g., epoxy), not shown.

FIGS. 1 and 4-7 are side cross-sectional views, e.g., taken along section line A-A in FIG. 2, of an evacuation structure according to various example embodiments, after evacuation and laser sintering/sealing of the bore tip to form a substantially dome-shaped bore tip seal 12a. Substantially dome-shaped tip seals 12a, shown in FIGS. 1 and 4-7, may be formed for example by using a spot laser to quickly heat the top end area of bore 12 to melt same so that the substantially dome-shaped tip seal 12a can be formed using material from the substrate 1 itself. Dome-shaped tip seal 12a may be substantially horizontally oriented (e.g. see FIGS. 4-7), or alternatively may be angled relative to the horizontal in certain example embodiments. The substantially lens-shaped and/or dome-shaped tip seal 12a may include a number of air/gas bubbles therein in certain example embodiments, although it has been found that using a laser to form the seal may advantageously reduce the number of air/gas bubbles/voids in the tip seal thereby improving strength/durability thereof. While the bore tip seal 12a may be substantially dome-shaped and/or substantially lens-shaped in certain example embodiments (e.g., see FIGS. 1, 4-7), other tip seal shapes are possible in other embodiments.

As shown in FIGS. 1 and 4-7, at least part of the top side of tip seal 12a may be convex (e.g., see convex top side 12b of the tip seal in various figures). The laser can quickly heat the top end area of the bore 12 so that the glass quickly melts so that the substantially lens-shaped and/or dome-shaped tip seal 12a can be formed with a top surface that is at least partially convex (e.g., see convex surface 12b) before the entirety of the glass at the top of the dome sags or slumps into the hollow of the bore 12, thereby providing a more durable shape for the bore tip seal 12a of the elongated bore. In certain example embodiments, as shown in FIGS. 1 and 4-7 for example, the bottom surface/side of the tip seal 12a may be concave shaped, as shown by concave surface 12c. The upper 12b and lower 12c surfaces of the tip seal 12a may both be arcuate, or substantially arcuate, in shape in certain example embodiments. The combination of the convex surface 12b on the top, and the concave surface 12c on the bottom of the tip seal 12a, has been found to structurally improve durability of the tip seal and thus the durability and hermiticity of the vacuum insulating panel. Thus, as shown in FIGS. 1 and 4-7, in certain example embodiments the tip seal 12a may include an upper side 12b comprising a convex surface and a lower side 12c comprising a concave surface, the lower side 12c being closer to the gap 5 than is the upper side 12b, so that the convex surface 12b arcs away from the low pressure space 5 and the concave surface 12c arcs toward the lower pressure space/gap 5. All or part of the upper side 12b may be convex, and/or all or part of the lower side 12c may be concave, in various example embodiments. Moreover, in these respects, as shown in various figures, in certain example embodiments, for at least one location viewed cross-sectionally no more than about 0.2 mm from a wall of the bore 12, a surface and/or side 12c of the tip seal extending inwardly away from the wall of the bore may form an angle Δ of from 35-85 degrees, more preferably from 40-80 degrees, and most preferably from 45-80 degrees, with the adjacent sidewall of the bore 12.

In certain example embodiments, for at least one location, the substantially dome-shaped tip seal 12a may have a glass thickness D_{T}, in a direction parallel to the lengthwise axis of the bore 12, of at least about 0.2 mm, more preferably of at least about 0.3 mm, with an example being about 0.35 mm. In certain example embodiments, the substantially dome-shape tip seal 12a may have a minimum glass thickness, in any suitable direction, of at least about 0.15 mm, more preferably of at least about 0.2 mm, more preferably of at least about 0.25 mm. In certain example embodiments, for at least one location viewed cross-sectionally in a direction parallel to the lengthwise axis of the bore 12, the substantially lens-shaped and/or substantially dome-shaped tip seal 12a may have a thickness greater than a thickness of an upper portion of vertical wall 60 of the bore 12 prior to sealing. Example technical advantage(s) regarding the above substantially dome-shaped and/or substantially lens-shaped tip seal 12a, for example, may include one or more of: improved evacuation structure hermiticity, reduced seal and/or glass breakage, reduced crack formation, improved moisture resistance, improved thermal stability during asymmetric thermal conditions, improved durability, and/or improved tip sealing.

One or both of substrates 1 and/or 2, in certain example embodiments, may be of or include soda-lime-silica flat glass as their base composition/glass. Clear or substantially clear glass may be used. In addition to base composition/glass in Table 1 below, a colorant portion may be provided in the glass order to achieve a glass that is clear, bronze, green, blue, or otherwise colored, and/or to allow for a desired (e.g., high) visible transmission. An exemplary soda-lime-silica base glass, which may be used for at least one of glass substrates 1 and/or 2 in certain example embodiments, may include on a weight percentage basis the following basic ingredients (not including colorant portion):

### TABLE 1: EXAMPLE BASE GLASS FOR SUBSTRATE(S) 1 AND/OR 2

### Ingredient Wt. %

Silicon oxide (e.g., SiO₂) 60-75%
Sodium oxide (e.g., Na₂O) 10-20%
Calcium oxide (e.g., CaO) 5-15%
Magnesium oxide (e.g., MgO) 0-8%
Aluminum oxide (e.g., Al₂O₃) 0-7% (or 0-5%)
Potassium oxide (e.g., K₂O) 0-5%
Barium oxide (e.g., BaO) 0-1%
   Other ingredients, including various colorant(s) such as iron and/or conventional refining aids, such as SO₃, carbon, and the like may also be included in the glass. Certain soda-lime-silica based glasses may include by weight from about 10-15% sodium oxide (e.g., Na₂O and/or other stoichiometry) and from about 6-12% calcium oxide (e.g., CaO and/or other stoichiometry). Thus, other elements (e.g., iron, erbium, cerium, sulfur, carbon, cobalt, etc.) may also be present in the glass. The above glass composition ranges may apply to float glass of the soda-lime-silica type. However, as explained herein, other types of glass may be used for substrate(s) 1 and/or 2, such as borosilicate glass, lithia aluminosilicate glass, and so forth. Thus, the substrate 1 and/or 2, and the evacuation bore structure 12, 15 may be formed of such material in certain example embodiments.

In certain example embodiments, one or both of the glass substrates 1 and/or 2 may include, with respect to wt. %, total iron (expressed as Fe₂O₃) in an amount of from about 0.0005 to 1.25%, more preferably from about 0.0005 to 1.0%, more preferably from about 0.0005 to 0.50%, more preferably from about 0.0005 to 0.30%, more preferably from about 0.0005 to 0.25%, more preferably from about 0.05 to 0.20%, and most preferably from about 0.05 to 0.18%. Iron is a known glass colorant, and in certain example embodiments low amounts of iron may be used to provide for a relatively clear glass, which may optionally have a relatively high visible transmission. The total amount of iron is expressed herein in terms of “Fe₂O₃” in accordance with standard practice. This, however, does not mean that all iron is in the form of Fe₂O₃, as the iron of the total iron may be present for example in both the ferrous state (Fe⁺²) and the ferric state, and/or other oxidation state(s). Iron in the ferrous state (Fe²⁺; FeO) is a blue-green colorant, while iron in the ferric state (Fe³⁺; Fe₂O₃) is a yellow-green colorant. All states of iron (e.g., including ferrous and ferric states, and thus iron oxides thereof) are included herein when using the phrase “total iron” and/or when using the phrase “expressed as Fe₂O₃.” Thus, for example, the phrases “total iron” and “total iron (expressed as Fe₂O₃)” as used herein may include both FeO and Fe₂O₃, as well as iron in any other oxidation state. The proportion of the total iron in the ferrous state (FeO) is used to determine the redox state of the glass, and redox is expressed as the ratio FeO/Fe₂O₃, which is the weight percentage (%) of iron in the ferrous state (FeO) divided by the weight percentage (%) of total iron (expressed as Fe₂O₃) in the resulting glass. In certain example embodiments, for example and without limitation, glass may have a glass redox value (i.e., FeO/Fe₂O₃) of from about 0.02 to 0.60, more preferably from about 0.05 to 0.30. The above glass compositions, total iron contents and glass redox values apply for example to known clear glass compositions for substrate(s) 1 and/or 2 that are commercially available for example from companies such as Vittro, St. Gobain, or Cardinal, and may apply to other clear glasses, neutral colored glasses, or otherwise colored glasses.

In certain example embodiments, one or both glass substrates 1 and/or 2 may have a visible transmission (Tᵥᵢₛ) of at least about 50%, more preferably of at least about 60%, more preferably of at least about 70%, and most preferably of at least about 80%, or at least about 85%; such transmission values may be achieved at, for example, a non-limiting reference glass thickness of from about 3-6 mm.

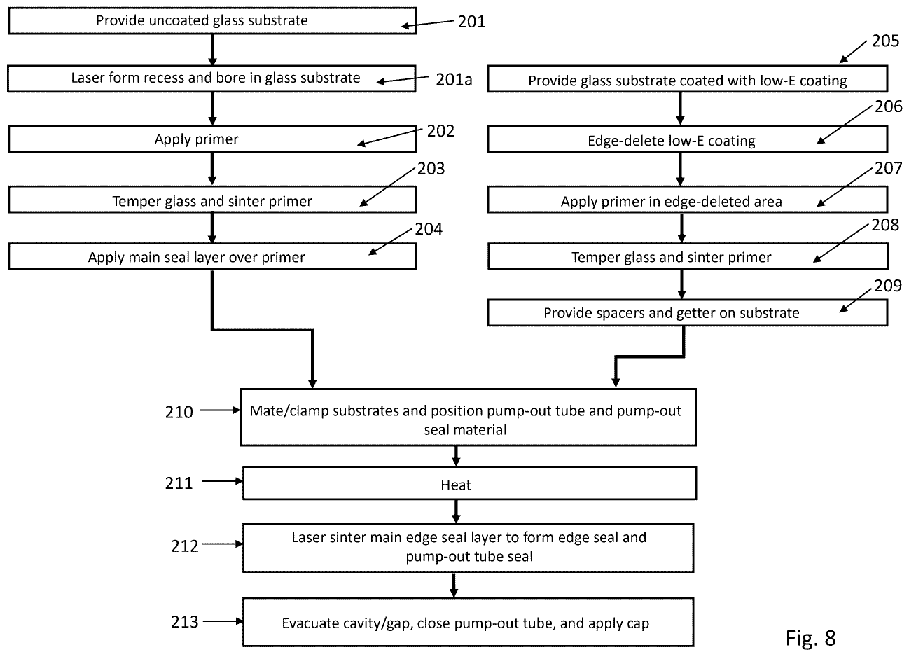

FIG. 8 is a flowchart illustrating example steps in making a vacuum insulating panel according to various example embodiments, which may be used in combination with any embodiment herein. Steps 201-204 apply to one of the two substrates, while steps 205-209 apply to the other one of the substrates, and steps 210-213 apply when the substrates are mated to each other via clamping, sealing, and/or the like. For example details regarding various steps 201-213, see one or more of U.S. Patent Documents 2024/0167324 and US 2024/0167320, the disclosures of which are all hereby incorporated herein by reference in their entireties. It is noted that, in certain example embodiments, step 201a involving the laser formation of recess 15 and bore 12 in substrate 1 (or substrate 2) as discussed above may occur between steps 201 and 202. And the formation of bore tip seal 12a may occur at 213.

In an example embodiment, there is provided a vacuum insulating panel comprising: a first glass substrate (e.g., 1 or 2); a second glass substrate (e.g., the other of 1 or 2); a plurality of spacers (e.g., 4) provided in a gap (e.g., 5) between at least the first and second glass substrates, wherein the gap (e.g., 5) is at pressure less than atmospheric pressure; an evacuation bore structure comprising glass of the first glass substrate, the evacuation bore structure comprising: an elongated evacuation bore (e.g., 12), formed in glass of the first glass substrate, extending away from the gap and exposed to the gap; a tip seal (e.g., 12a) of the bore comprising glass of and/or from the first glass substrate; and a recess (e.g., 15) formed in the first glass substrate and surrounding the bore as viewed from above, wherein at least part of the bore extends from the gap beyond a base (e.g., 57) of the recess; wherein the evacuation bore structure does not include any separate evacuation tube permanently mounted to the first substrate.

In an example embodiment, there is be provided a vacuum insulating panel comprising: a first glass substrate (e.g., 1 or 2); a second glass substrate (e.g., the other of 1 or 2); a plurality of spacers (e.g., 4) provided in a gap (e.g., 5) between at least the first and second glass substrates, wherein the gap (e.g., 5) is at pressure less than atmospheric pressure; an evacuation bore structure comprising glass of the first glass substrate, the evacuation bore structure comprising: an evacuation bore (e.g., 12), formed in glass of the first glass substrate, extending away from the gap; a tip seal (e.g., 12a) of the bore comprising glass of and/or from the first glass substrate, wherein a top of the tip seal is at elevation below an adjacent major surface (e.g., 52) of the first glass substrate; a recess (e.g., 15) formed in the first glass substrate and at least partially surrounding the bore as viewed from above; and a wall (e.g., 60) separating an interior of the bore from the recess.

In an example embodiment, there is provided a vacuum insulating panel comprising: a first substrate (e.g., glass or other suitable material) (e.g., 1 or 2); a second substrate (e.g., glass or other suitable material) (e.g., the other of 1 or 2); a plurality of spacers (e.g., 4) provided in a gap (e.g., 5) between at least the first and second substrates, wherein the gap (e.g., 5) is at pressure less than atmospheric pressure; an evacuation bore structure comprising material of the first substrate, the evacuation bore structure comprising: an evacuation bore (e.g., 12), formed in the first substrate, extending away from the gap; a tip seal (e.g., 12a) of the bore comprising material of and/or from the first substrate; and a recess (e.g., 15) formed in the first substrate and surrounding the bore as viewed from above; wherein the evacuation bore structure does not contain any separate and/or foreign seal material sealing off the gap from an atmospheric pressure area.

In an example embodiments, there is provided a vacuum insulating panel comprising: a first glass substrate (e.g., 1 or 2); a second glass substrate (e.g., the other of 1 or 2); a plurality of spacers (e.g., 4) provided in a gap (e.g., 5) between at least the first and second glass substrates, wherein the gap (e.g., 5) is at pressure less than atmospheric pressure; an evacuation bore (e.g., 12) comprising glass; wherein an end portion and/or tip portion of the evacuation bore is sealed to form a tip seal (e.g., 12a), wherein the tip seal includes a first side comprising a convex surface (e.g., 12b) and a second side comprising a concave surface (e.g., 12c), the second side located closer to the gap than is the first side, so that the convex surface arcs away from the gap and the concave surface arcs toward the gap.

In certain example embodiments, the vacuum insulating panel of any of the preceding four paragraphs does not contain any separate and/or foreign seal material sealing off an atmospheric pressure area from the gap at pressure less than atmospheric pressure.

In certain example embodiments, the vacuum insulating panel of any of the preceding five paragraphs does not contain any separate and/or foreign sealing plug for sealing the bore and/or sealing off an atmospheric pressure area from the gap.

In the vacuum insulating panel of any of the preceding six paragraphs, at least a portion of the bore may protrude upwardly to an elevation above a base of the recess.

In the vacuum insulating panel of any of the preceding seven paragraphs, the tip seal of the bore may consist essentially of glass of and/or from the first substrate.

In the vacuum insulating panel of any of the preceding eight paragraphs, the bore may consist essentially of glass of and/or from the first substrate.

In the vacuum insulating panel of any of the preceding nine paragraphs, the evacuation bore structure may consist essentially of glass of and/or from the first substrate.

In the vacuum insulating panel of any of the preceding ten paragraphs, the bore and/or recess may be carved (e.g., laser carved) into the first substrate.

In the vacuum insulating panel of any of the preceding eleven paragraphs, the first substrate may be configured to be located on a building interior side, or a building exterior side, of the vacuum insulating panel when used in a window for example.

In the vacuum insulating panel of any of the preceding twelve paragraphs, the panel may further comprise a cover (not part of the evacuating bore structure) that covers at least part of the evacuation bore structure.

In the vacuum insulating panel of any of the preceding thirteen paragraphs, the evacuation bore structure may comprise a wall (e.g., 60) separating an interior of the bore from the recess.

In the vacuum insulating panel of any of the preceding fourteen paragraphs, at least a portion of the bore may protrude upwardly from a base of the recess.

In the vacuum insulating panel of any of the preceding fifteen paragraphs, the recess may comprise an outer sidewall, at least part of which may be oriented substantially perpendicular to an adjacent major surface of the first substrate.

In the vacuum insulating panel of any of the preceding sixteen paragraphs, the recess may comprise an angled sidewall (e.g., 58, stepped or smooth) extending away from the base of the recess substantially toward the tip seal of the bore. At least part of the angled sidewall of the recess may be oriented so as to define an angle β of from about 10-70 degrees with an adjacent wall of bore, more preferably from about 30-60 degrees with an adjacent wall of bore.

In the vacuum insulating panel of any of the preceding seventeen paragraphs, an entirety of the tip seal (e.g., 12a) may be positioned at elevation below an adjacent major surface (e.g., 52) of the first substrate, as viewed in FIGS. 1, 4-7 for example.

In the vacuum insulating panel of any of the preceding eighteen paragraphs, an end portion and/or tip portion of the bore may be sealed to form the tip seal, wherein the tip seal may include a first side comprising a convex surface and a second side comprising a concave surface, the second side located closer to the gap than is the first side, so that the convex surface arcs away from the gap and the concave surface arcs toward the gap. An apex of the convex surface may extend away from the gap, and an apex of the concave surface may extend toward the gap.

In the vacuum insulating panel of any of the preceding nineteen paragraphs, the tip seal may be laser-formed.

In the vacuum insulating panel of any of the preceding twenty paragraphs, at least one location of the tip seal may have a glass thickness (D_{T}), in a direction parallel to a lengthwise axis of the bore, of at least 0.3 mm.

In the vacuum insulating panel of any of the preceding twenty-one paragraphs, a ratio D_{T}/D_{W} may be at least about 1.5 (more preferably at least about 2.0), wherein D_{T} is a glass thickness of the tip seal, at one or more locations, in a direction parallel to a lengthwise axis of the bore, and D_{W} is a wall thickness of the bore for at least one location in a direction transverse to the lengthwise axis of the bore.

In the vacuum insulating panel of any of the preceding twenty-two paragraphs, the first substrate may comprise soda-lime-silica based glass or borosilicate based glass for example.

In the vacuum insulating panel of any of the preceding twenty-three paragraphs, a lengthwise axis of the bore may be oriented substantially perpendicular to major substantially parallel surfaces of the first substrate, and thus substantially perpendicular to a thickness direction of the first glass substrate.

In the vacuum insulating panel of any of the preceding twenty-four paragraphs, a depth (DP_{R}) of the recess may be from about 40-75% (more preferably from about 45-70%) of a thickness (T_{S}) of the first substrate.

In the vacuum insulating panel of any of the preceding twenty-five paragraphs, the first and second glass substrates may comprise tempered glass substrates or heat strengthened glass substrates.

In the vacuum insulating panel of any of the preceding twenty-six paragraphs, the panel may be configured for use in a window.

In the vacuum insulating panel of any of the preceding twenty-seven paragraphs, the panel may further comprise an edge seal provided at least partially between the first and second substrates.

In the vacuum insulating panel of any of the preceding twenty-eight paragraphs, a ratio DP_{R}/T_{S} may optionally be no greater than about 0.67 (more preferably no greater than about 0.55, more preferably no greater than about 0.50, more preferably no greater than about 0.47), where DP_{R} is a depth of the recess and T_{S} is a thickness of the first substrate.

In the vacuum insulating panel of any of the preceding twenty-nine paragraphs, the first and/or second substrates may be glass substrates, and a composition of the first and/or second glass substrate(s) may comprise:
Ingredient wt. %
silicon oxide 60-75%
sodium oxide 10-20%
calcium oxide 5-15%
total iron (expressed as Fe₂O₃) 0.0005-1.25%.

It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). Terms, such as “first”, “second”, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component. “Or” as used herein may cover both “and” and “or.”

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component. Thus, terms such as “connected” and “coupled” cover both direct and indirect connections and couplings.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The word “about” as used herein means the identified value plus/minus 5%.

“On” as used herein covers both directly on, and indirectly on with intervening element(s) therebetween. Thus, for example, if element A is stated to be “on” element B, this covers element A being directly and/or indirectly on element B. Likewise, “supported by” as used herein covers both in physical contact with, and indirectly supported by with intervening element(s) therebetween.

Each embodiment herein may be used in combination with any other embodiment(s) described herein.

While the disclosure has been illustrated and described with reference to various example embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in combination with any other embodiment(s) described herein.

1. A vacuum insulating panel comprising:
a first glass substrate;
a second glass substrate;
a plurality of spacers provided in a gap between at least the first and second glass substrates, wherein the gap is at pressure less than atmospheric pressure;
an evacuation bore structure comprising glass of the first glass substrate, the evacuation bore structure comprising:
an elongated evacuation bore, formed in glass of the first glass substrate, extending away from the gap and exposed to the gap;
a tip seal of the bore comprising glass of and/or from the first glass substrate; and
a recess formed in the first glass substrate and surrounding the bore as viewed from above, wherein at least part of the bore extends from the gap beyond a base of the recess;
wherein the evacuation bore structure does not include any separate evacuation tube permanently mounted to the first substrate.

2. The vacuum insulating panel of claim 1, wherein the evacuation bore structure does not contain any separate and/or foreign seal material sealing off an atmospheric pressure area from the gap at pressure less than atmospheric pressure.

3. The vacuum insulating panel of claim 1, wherein the evacuation bore structure does not contain any separate and/or foreign sealing plug for sealing the bore and/or sealing off an atmospheric pressure area from the gap.

4. The vacuum insulating panel of claim 1, wherein at least a portion of the bore protrudes upwardly to an elevation above the base of the recess.

5. The vacuum insulating panel of claim 1, wherein the tip seal of the bore consists essentially of glass of and/or from the first glass substrate.

6. The vacuum insulating panel of claim 1, wherein the bore consists essentially of glass of and/or from the first glass substrate.

7. The vacuum insulating panel of claim 1, wherein the evacuation bore structure consists essentially of glass of and/or from the first glass substrate.

8. The vacuum insulating panel of claim 1, wherein the bore and recess are carved into the first glass substrate.

9. The vacuum insulating panel of claim 1, wherein the bore and recess are laser-carved into the first glass substrate.

10. The vacuum insulating panel of claim 1, wherein the first glass substrate is configured to be located on a building interior side of the vacuum insulating panel.

11. The vacuum insulating panel of claim 1, further comprising a cover that covers at least part of the evacuation bore structure.

12. The vacuum insulating panel of claim 1, wherein the evacuation bore structure comprises a wall separating an interior of the bore from the recess.

13. The vacuum insulating panel of claim 1, wherein at least a portion of the bore protrudes upwardly from the base of the recess.

14. The vacuum insulating panel of claim 1, wherein the recess comprises an outer sidewall, at least part of the outer sidewall of the recess being oriented substantially perpendicular to an adjacent major surface of the first glass substrate.

15. The vacuum insulating panel of claim 1, wherein the recess comprises an angled sidewall extending away from the base of the recess substantially toward the tip seal of the bore.

16. The vacuum insulating panel of claim 15, wherein at least part of the angled sidewall of the recess is oriented so as to define an angle β of from about 10-70 degrees with an adjacent wall of bore.

17. The vacuum insulating panel of claim 15, wherein at least part of the angled sidewall of the recess is oriented so as to define an angle β of from about 30-60 degrees with an adjacent wall of bore.

18. The vacuum insulating panel of claim 1, wherein an entirety of the tip seal is at elevation below an adjacent major surface of the first glass substrate.

19. The vacuum insulating panel of claim 1, wherein an end portion and/or tip portion of the bore is sealed to form the tip seal, wherein the tip seal includes a first side comprising a convex surface and a second side comprising a concave surface, the second side located closer to the gap than is the first side, so that the convex surface arcs away from the gap and the concave surface arcs toward the gap.

20. The vacuum insulating panel of claim 19, wherein an apex of the convex surface extends away from the gap, and an apex of the concave surface extends toward the gap.

21. The vacuum insulating panel of claim 1, wherein the tip seal is laser-formed.

22. The vacuum insulating panel of claim 1, wherein at least one location of the tip seal has a glass thickness (D_{T}), in a direction parallel to a lengthwise axis of the bore, of at least 0.3 mm.

23. The vacuum insulating panel of claim 1, wherein a ratio D_{T}/D_{W} is at least about 1.5, wherein D_{T} is a glass thickness of the tip seal, at one or more locations, in a direction parallel to a lengthwise axis of the bore, and D_{W} is a wall thickness of the bore for at least one location in a direction transverse to the lengthwise axis of the bore.

24. The vacuum insulating panel of claim 1, wherein a ratop D_{T}/D_{W} is at least about 2.0, wherein D_{T} is a glass thickness of the tip seal, at one or more locations, in a direction parallel to a lengthwise axis of the bore, and D_{W} is a wall thickness of the bore for at least one location in a direction transverse to the lengthwise axis of the bore.

25. The vacuum insulating panel of claim 1, wherein a composition of the first and second glass substrates comprises:
Ingredient wt. %
silicon oxide 60-75%
sodium oxide 10-20%
calcium oxide 5-15%
total iron (expressed as Fe₂O₃) 0.0005-1.25%.

26. The vacuum insulating panel of claim 25, wherein each of the first and second glass substrates comprises from about 0.0005-0.30% total iron (expressed as Fe₂O₃) (wt. %).

27. The vacuum insulating panel of claim 1, wherein the first glass substrate comprises soda-lime-silica based glass or borosilicate based glass.

28. The vacuum insulating panel of claim 1, wherein a lengthwise axis of the bore is oriented substantially perpendicular to major substantially parallel surfaces of the first glass substrate.

29. The vacuum insulating panel of claim 1, wherein a depth (DP_{R}) of the recess is from about 40-75% of a thickness (T_{S}) of the first glass substrate.

30. The vacuum insulating panel of claim 1, wherein a ratio DP_{R}/T_{S} is no greater than about 0.67, where DP_{R} is a depth of the recess and T_{S} is a thickness of the first substrate.

31. The vacuum insulating panel of claim 1, wherein the first and second glass substrates comprise tempered glass substrates or heat strengthened glass substrates.

32. The vacuum insulating panel of claim 1, wherein the panel is configured for use in a window.

33. The vacuum insulating panel of claim 1, wherein the panel further comprises an edge seal provided at least partially between the first and second substrates.

34. A vacuum insulating panel comprising:
a first substrate;
a second substrate;
a plurality of spacers provided in a gap between at least the first and second substrates, wherein the gap is at pressure less than atmospheric pressure;
an evacuation bore structure comprising material of the first substrate, the evacuation bore structure comprising:
an evacuation bore, formed in the first substrate, extending away from the gap;
a tip seal of the bore comprising material of and/or from the first substrate; and
a recess formed in the first substrate and surrounding the bore as viewed from above;
wherein the evacuation bore structure does not contain any separate and/or foreign seal material sealing off the gap from an atmospheric pressure area.

35. The vacuum insulating panel of claim 34, wherein the evacuation bore structure does not include any separate evacuation tube permanently mounted to the first substrate.

36. The vacuum insulating panel of claim 34, wherein the evacuation bore structure does not contain any separate and/or foreign sealing plug for sealing the bore and/or sealing off the atmospheric pressure area from the gap.

37. The vacuum insulating panel of claim 34, wherein at least a portion of the bore protrudes upwardly to an elevation above a base of the recess.

38. The vacuum insulating panel of claim 34, wherein the tip seal of the bore consists essentially of material of and/or from the first substrate.

39. The vacuum insulating panel of claim 34, wherein the bore consists essentially of material of and/or from the first substrate.

40. The vacuum insulating panel of claim 34, wherein the evacuation bore structure consists essentially of material of and/or from the first substrate.

41. The vacuum insulating panel of claim 34, wherein the bore and recess are laser-carved into the first substrate.

42. The vacuum insulating panel of claim 34, further comprising a cover that covers at least part of the evacuation bore structure.

43. The vacuum insulating panel of claim 34, wherein the evacuation bore structure comprises a wall separating an interior of the bore from the recess.

44. The vacuum insulating panel of claim 34, wherein at least a portion of the bore protrudes upwardly from a base of the recess.

45. The vacuum insulating panel of claim 34, wherein the recess comprises an angled sidewall extending away from a base of the recess substantially toward the tip seal of the bore.

46. The vacuum insulating panel of claim 45, wherein at least part of the angled sidewall of the recess is oriented so as to define an angle β of from about 10-70 degrees with an adjacent wall of bore.

47. The vacuum insulating panel of claim 34, wherein an end portion and/or tip portion of the bore is sealed to form the tip seal, wherein the tip seal includes a first side comprising a convex surface and a second side comprising a concave surface, the second side located closer to the gap than is the first side, so that the convex surface arcs away from the gap and the concave surface arcs toward the gap.

48. The vacuum insulating panel of claim 47, wherein an apex of the convex surface extends away from the gap, and an apex of the concave surface extends toward the gap.

49. The vacuum insulating panel of claim 34, wherein the tip seal is laser-formed.

50. The vacuum insulating panel of claim 34, wherein the first substrate is a glass substrate with a composition thereof comprising:
Ingredient wt. %
silicon oxide 60-75%
sodium oxide 10-20%
calcium oxide 5-15%
total iron (expressed as Fe₂O₃) 0.0005-1.25%.

51. The vacuum insulating panel of claim 34, wherein a depth (DP_{R}) of the recess is from about 40-75% of a thickness (T_{S}) of the first substrate.

52. The vacuum insulating panel of claim 34, wherein a ratio DP_{R}/T_{S} is no greater than about 0.67, where DP_{R} is a depth of the recess and T_{S} is a thickness of the first substrate.

53. The vacuum insulating panel of claim 34, wherein a ratio DP_{R}/T_{S} is no greater than about 0.55, where DP_{R} is a depth of the recess and T_{S} is a thickness of the first substrate.

54. The vacuum insulating panel of claim 34, wherein a ratio DP_{R}/T_{S} is no greater than about 0.47, where DP_{R} is a depth of the recess and T_{S} is a thickness of the first substrate.

55. The vacuum insulating panel of claim 34, wherein the first and second substrates comprise tempered glass substrates or heat strengthened glass substrates.

56. The vacuum insulating panel of claim 34, wherein the panel is configured for use in a window.

57. A vacuum insulating panel comprising:
a first glass substrate;
a second glass substrate;
a plurality of spacers provided in a gap between at least the first and second glass substrates, wherein the gap is at pressure less than atmospheric pressure;
an evacuation bore structure comprising glass of the first glass substrate, the evacuation bore structure comprising:
an elongated evacuation bore, formed in glass of the first glass substrate, extending away from the gap;
a tip seal of the bore comprising glass of and/or from the first glass substrate;
a recess formed in the first glass substrate and surrounding the bore as viewed from above, wherein at least part of the bore extends from the gap beyond a base of the recess; and
a wall separating an interior of the bore from the recess;
wherein the bore, tip seal, wall, and recess each consist essentially of glass of and/or from the first glass substrate.

58. The vacuum insulating panel of claim 57, wherein the evacuation bore structure does not contain any separate and/or foreign seal material sealing off an atmospheric pressure area from the gap.

59. The vacuum insulating panel of claim 57, wherein the evacuation bore structure does not include any separate evacuation tube permanently mounted to the panel.

60. A vacuum insulating panel comprising:
a first glass substrate;
a second glass substrate;
a plurality of spacers provided in a gap between at least the first and second glass substrates, wherein the gap is at pressure less than atmospheric pressure;
an evacuation bore structure comprising glass of the first glass substrate, the evacuation bore structure comprising:
an evacuation bore, formed in glass of at least the first glass substrate, extending away from the gap;
a tip seal of the bore comprising glass of and/or from the first glass substrate, wherein a top of the tip seal is at elevation below an adjacent major surface of the first glass substrate;
a recess formed in the first glass substrate and at least partially surrounding the bore as viewed from above; and
a wall separating an interior of the bore from the recess.

61. A vacuum insulating panel comprising:
a first glass substrate;
a second glass substrate;
a plurality of spacers provided in a gap between at least the first and second glass substrates, wherein the gap is at pressure less than atmospheric pressure;
an evacuation bore structure comprising glass of at least one of the first and second glass substrates, the evacuation bore structure comprising:
an elongated evacuation bore, formed in glass of at least one of the first and second glass substrates, extending from the gap and exposed to the gap;
a tip seal of the bore comprising glass of and/or from at least one of the first and second glass substrates; and
a recess formed in at least one of the first and second glass substrates, and surrounding at least part of the bore; and
wherein the evacuation bore structure does not include any separate evacuation tube permanently mounted to the first substrate.

62. A vacuum insulating panel comprising:
a first glass substrate;
a second glass substrate;
a plurality of spacers provided in a gap between at least the first and second glass substrates, wherein the gap is at pressure less than atmospheric pressure;
an evacuation bore comprising glass;
wherein an end portion and/or tip portion of the evacuation bore is sealed to form a tip seal, wherein the tip seal includes a first side comprising a convex surface and a second side, the second side located closer to the gap than is the first side, so that the convex surface arcs away from the gap; and
wherein a ratio D_{T}/D_{W} is at least about 2.0, wherein D_{T} is a glass thickness of the tip seal, for at least one location, in a direction parallel to a lengthwise axis of the bore, and D_{W} is a wall thickness of the bore for at least one location in a direction transverse to the lengthwise axis of the bore.

63. A method of making a vacuum insulating panel comprising a first glass substrate;
a second glass substrate; a plurality of spacers provided in a gap between at least the first and second glass substrates; and an evacuation bore structure comprising glass of the first glass substrate; the method comprising:
laser carving a recess and an elongated evacuation bore into the first glass substrate, the bore formed in glass of the first glass substrate and extending away from the gap and exposed to the gap, and the recess formed in the glass of the first glass substrate and surrounding the bore as viewed from above;
evacuating the gap via the evacuation bore; and
after the evacuating of the gap, laser sealing a top and/or tip portion of the bore to form a tip seal of the bore comprising glass of and/or from the first glass substrate;
wherein the evacuation bore structure does not include any separate evacuation tube permanently mounted to the first substrate.

64. The method of claim 63, wherein the laser sealing to form the tip seal comprises directing a laser beam at an end of the bore to seal an end portion of the bore to form the tip seal in a manner so that the tip seal includes a first side comprising a convex surface and a second side comprising a concave surface, the second side located closer to the gap than is the first side, so that the convex surface arcs away from the gap and the concave surface arcs toward the gap.
